(19) United States
(12) Patent Application Publication
(10) Pub. No.: US 2025/0296367 A1
(43) Pub. Date: Sep. 25, 2025

(54) IMAGE FORMING APPARATUS

(71) Applicant: CANON KABUSHIKI KAISHA, Tokyo (JP)

(72) Inventor: SHINNOSUKE IWADATE, Ibaraki (JP)

(21) Appl. No.: 19/084,130

(22) Filed: Mar. 19, 2025

(30) Foreign Application Priority Data
Mar. 22, 2024 (JP) 2024-047365

(51) Int. Cl. B41J 13/00; B41J 3/60; B41J 11/00; B41J 13/10; B41J 29/13

(52) U.S. Cl. CPC B41J 13/0036; B41J 3/60; B41J 11/003; B41J 11/0095; B41J 13/0045; B41J 13/106; B41J 29/13

(57) ABSTRACT

An image forming apparatus includes a first stacking portion, a second stacking portion, a conveyance portion, an error detection portion, and a control portion configured to control the conveyance portion. The control portion is configured to execute (i) a first recovery operation in a case where the first error is detected, the first recovery operation being an operation that is executed to recover from the first error, and that controls the conveyance portion to discharge a sheet to the first stacking portion and not to discharge a sheet to the second stacking portion, and (ii) a second recovery operation in a case where the second error is detected, the second recovery operation being an operation that is executed to recover from the second error, and that controls the conveyance portion to discharge a sheet to at least one of the first stacking portion and the second stacking portion.

### BACKGROUND OF THE INVENTION

### Field of the Invention

The present invention relates to an image forming apparatus that forms images on sheets.

### Description of the Related Art

Japanese Patent Application Publication No. 2007-69440 proposes an image forming system that includes an upstream apparatus, an intermediate apparatus, and a downstream apparatus. Each of the upstream apparatus, the intermediate apparatus, and the downstream apparatus includes a conveyance path for conveying sheets, and the conveyance paths of the apparatuses are disposed so as to be continuous with each other. The intermediate apparatus includes an escape tray connected to the conveyance path. In a case where a jam (sheet jam) has occurred in a position downstream of the escape tray in a sheet conveyance direction, a sheet located upstream of the escape tray in the sheet conveyance direction is discharged to the escape tray. In this manner, in a case where a jam (sheet jam) has occurred, a less number of sheets are left in the conveyance paths, so that the jam handling performance can be increased.

By the way, in an image forming system, for reducing the number of sheets left in the image forming system in a case where a jam has occurred, it is desired to dispose escape trays in a plurality of positions in the image forming system. In general, there is a known error, other than the jam, from which the image forming operation can be resumed without being stopped.

However, in a case where an escape tray is disposed at a position where the escape tray cannot be accessed during the image forming operation, if sheets are fully stacked on the escape tray, the image forming operation has to be stopped for performing the operation for resuming the image forming operation from the above-described error. This causes the reduction in productivity.

### SUMMARY OF THE INVENTION

According to one aspect of the present invention, an image forming apparatus includes a casing, an image forming portion configured to execute an image forming operation that forms an image on a sheet, a door portion openably and closably supported by the casing, a first stacking portion which is disposed so as to be exposed to an outside of the casing, and on which a sheet is stacked, a second stacking portion which is disposed in the casing so as not to be exposed to the outside of the casing in a state where the door portion is closed with respect to the casing, and on which a sheet is stacked, a conveyance portion configured to convey a sheet, an error detection portion configured to detect a first error and a second error, the first error being an error that allows the image forming operation to continue, the second error being an error that does not allow the image forming operation to continue, and a control portion configured to control the conveyance portion. The control portion is configured to execute (i) a first recovery operation in a case where the first error is detected by the error detection portion, the first recovery operation being an operation that is executed to recover from the first error, and that controls the conveyance portion to discharge a sheet to the first stacking portion and not to discharge a sheet to the second stacking portion, and (ii) a second recovery operation in a case where the second error is detected by the error detection portion, the second recovery operation being an operation that is executed to recover from the second error, and that controls the conveyance portion to discharge a sheet to at least one of the first stacking portion and the second stacking portion.

Further features of the present invention will become apparent from the following description of exemplary embodiments with reference to the attached drawings.

### BRIEF DESCRIPTION OF THE DRAWINGS

FIG. 1 is a hardware block diagram of an image forming apparatus.

FIG. 2 is a cross-sectional view illustrating the image forming apparatus.

FIG. 3A is a plan view illustrating a floating-state detection portion.

FIG. 3B is a side view illustrating the floating-state detection portion in a state where a normal sheet is being conveyed.

FIG. 3C is a side view illustrating the floating-state detection portion in a state where a floating sheet is being conveyed.

FIG. 4A is a plan view illustrating a size detection portion.

FIG. 4B is a plan view illustrating a sheet size and an image size.

FIG. 5A is a cross-sectional view illustrating a sheet conveyance state where a single-side 18-sheets job is being executed.

FIG. 5B is a cross-sectional view illustrating a state where the single-side 18-sheets job is completed.

FIG. 6A is a diagram illustrating sheet information managed by a job management portion at a timing illustrated in FIG. 5A.

FIG. 6B is a diagram illustrating sheet information managed by the job management portion at a timing illustrated in FIG. 5B.

FIG. 7A is a cross-sectional view illustrating a sheet conveyance state where a double-side 26-sheets job is being executed.

FIG. 7B is a cross-sectional view illustrating a state where the double-side 26-sheets job is completed.

FIG. 8A is a diagram illustrating sheet information managed by the job management portion at a timing illustrated in FIG. 7A.

FIG. 8B is a diagram illustrating sheet information managed by the job management portion at a timing illustrated in FIG. 7B.

FIG. 9A is a cross-sectional view illustrating a sheet conveyance state where a double-side 26-sheets job is being executed.

FIG. 9B is a cross-sectional view illustrating a state where an escape discharge process is completed after a jam is detected.

FIG. 10A is a diagram illustrating sheet information managed by the job management portion at a timing illustrated in FIG. 9A.

FIG. 10B is a diagram illustrating sheet information managed by the job management portion at a timing illustrated in FIG. 9B.

FIG. 11 is a front view illustrating the image forming apparatus.

FIG. 12A is a diagram illustrating a relationship between a sheet position and an escape discharge tray in the escape discharge process for resuming the image forming operation from a first error.

FIG. 12B is a diagram illustrating a relationship between a sheet position and an escape discharge tray in the escape discharge process for resuming the image forming operation from a second error.

FIG. 13 is a flowchart illustrating the escape discharge process.

### DESCRIPTION OF THE EMBODIMENTS

### Hardware Configuration of Image Forming Apparatus

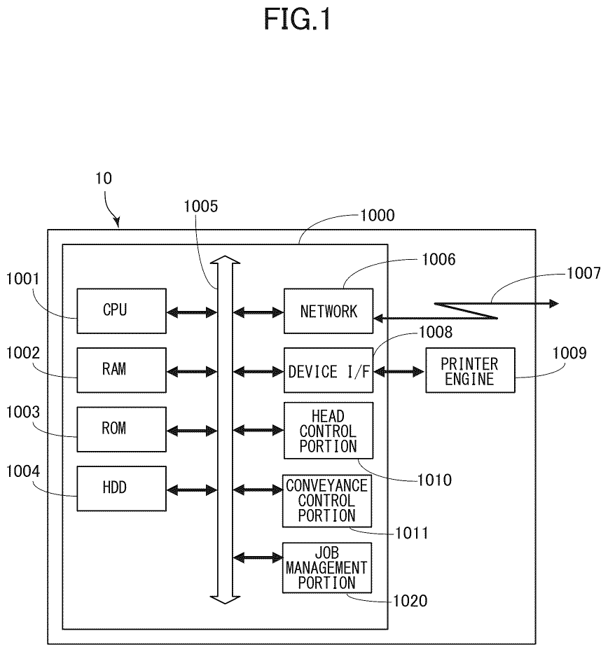

FIG. 1 is a hardware block diagram of an image forming apparatus 10 of the present embodiment. The image forming apparatus 10 includes a controller unit 1000 that serves as a control portion. The controller unit 1000 controls input and output of sensor signals and device information. The controller unit 1000 includes a central processing unit (CPU) 1001, a random access memory (RAM) 1002, a read only memory (ROM) 1003, and an HDD 1004.

The ROM 1003 or the HDD 1004 stores a program in which a process is written. The CPU 1001 reads the program stored in the ROM 1003 or the HDD 1004, from the ROM 1003 or the HDD 1004; stores the program in the RAM 1002; and executes the program. In addition, the CPU 1001 collectively controls the devices connected to a system bus 1005. The RAM 1002 functions as a main memory or a work memory of the CPU 1001. The ROM 1003 stores a boot program executed when power is turned on, and the HDD 154 stores an operating system and the main body of the control program of the image forming apparatus 10.

The HDD 1004 is also used for storing a large amount of data temporarily or for a longer time. A Network 1006 is connected to a local area network 1007, and sends/receives data or device information to/from an external apparatus. The program may be installed in the ROM 1003 or the HDD 1004 via the Network 1006. A device I/F 1008 is an interface portion between the CPU 1001 and a printer engine 1009, and sends/receives signals for operating or referring to various motors, sensors, and the ink-jet head connected to the printer engine 1009. The printer engine 1009 is an ink-jet output device that conveys a printing sheet (sheet), depending on the load control from the controller unit 1000, and that outputs an image onto the printing sheet by controlling the ink-jet head.

A job management portion 1020 receives a print job sent via the Network 1006, manages the conveyance timing of each sheet, assigns a print image to a corresponding sheet, and performs the setting of a below-described discharging tray. A conveyance control portion 1011 controls conveyance motors and sensors in a period of time from when each printing sheet is fed, until when the sheet is discharged to the outside of the image forming apparatus. A head control portion 1010 controls an ink-jet head included in the printer engine 1009, via the device I/F 1008; and performs ink ejection control for forming an image in synchronization with a timing at which a corresponding sheet reaches the ejection position of the ink-jet head.

### Overall Configuration of Image Forming Apparatus

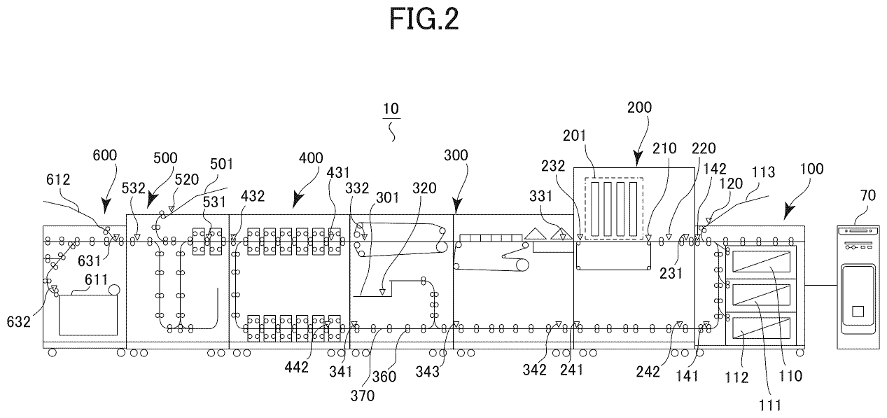

FIG. 2 is a cross-sectional view illustrating the image forming apparatus 10 of the present embodiment. As illustrated in FIG. 2, the image forming apparatus 10 is constituted by six units: a sheet feeding portion 100, a print portion 200, a fixing portion 300, a cooling portion 400, a reversing portion 500, and a discharging portion 600.

The sheet feeding portion 100 includes feeding cassettes 110, 111, and 112, on which a variety of sheets (printing sheets) used in a print process is stacked; and a sheet-feeding-portion escape tray 113, to which a sheet discharged is stacked. The sheet feeding portion 100 also includes a sheet-feeding-portion escape tray sensor 120 that detects a sheet stacked on the sheet-feeding-portion escape tray 113. Note that the sheet used in the present embodiment may be a paper sheet, such as a sheet for any purpose or an envelope, a plastic film such as an overhead projector (OHP) sheet, or a cloth sheet.

The print portion 200 is a unit that prints a print image on a sheet. The print portion 200 includes an ink-jet head 201, a print belt 202, a floating-state detection portion 210, and a size detection portion 220. The ink-jet head 201 that serves as an image forming portion ejects ink to a sheet conveyed by the print belt 202, and thereby forms an image on the sheet. The floating-state detection portion 210 detects floating of a sheet placed on the print belt 202. The size detection portion 220 detects the size of a sheet conveyed to the print portion 200.

The fixing portion 300 is a unit that performs fixing control for fixing an image printed by the print portion 200, to a sheet. The fixing portion 300 fixes a print image to a sheet by using a plurality of heater units (not illustrated). The fixing portion 300 includes a duplex-reversing escape tray 301 on which a sheet discharged is stacked. The duplex-reversing escape tray 301 is disposed so as to branch from a duplex conveyance path 370. In addition, the fixing portion 300 includes a duplex-reversing escape tray sensor 320 that detects a sheet stacked on the duplex-reversing escape tray 301.

The cooling portion 400 is a unit that cools a sheet heated by the fixing portion 300. The cooling portion 400 cools the sheet by using a plurality of fan units (not illustrated). The reversing portion 500 is a unit that can reverse and convey a sheet by switch-backing the sheet. The reversing portion 500 reverses and conveys a sheet for switching the state of the sheet between a state where the sheet is to be stacked with a printed surface serving as an upper surface, and a state where the sheet is to be stacked with the printed surface serving as a lower surface. The reversing portion 500 includes a reversing-portion escape tray 501 on which a sheet discharged is stacked, and a reversing-portion escape tray sensor 520 which detects a sheet stacked on the reversing-portion escape tray 501. The discharging portion 600 is a unit that performs discharging control on a printed sheet. The discharging portion 600 includes a sheet-discharging stacker tray 611 and an upper-surface discharge tray 612.

Each of the above-described six units includes a plurality of conveyance roller pairs for conveying a sheet, and a plurality of conveyance-path sensors for detecting a sheet conveyed by the conveyance roller pairs. For example, the fixing portion 300 includes conveyance roller pairs 360 that serve as a conveyance portion. Each conveyance roller pair of the conveyance roller pairs 360 or the like is controlled in conveyance by the conveyance control portion 1011 of the controller unit 1000 in a below-described escape discharge process. The sheet feeding portion 100 includes conveyance-path sensors 141 and 142; and the print portion 200 includes conveyance-path sensors 231, 232, 241, and 242. The fixing portion 300 includes conveyance-path sensors 331, 332, 341, 342, and 343; and the cooling portion 400 includes conveyance-path sensors 431, 432, and 442. The reversing portion 500 includes conveyance-path sensors 531 and 532; and the discharging portion 600 includes conveyance-path sensors 631 and 632. The image forming apparatus 10 can determine whether a sheet that is being conveyed is jammed, by using the above-described conveyance-path sensors.

The image forming apparatus 10 is connected with a print server 70, and a print job is sent from the print server 70 to the image forming apparatus 10. The print server 70 can be used for checking the state of the image forming apparatus 10, monitoring a print job, and performing the maintenance control. Thus, a user can operate the whole of various functions of the image forming apparatus 10.

### Sheet Floating Error

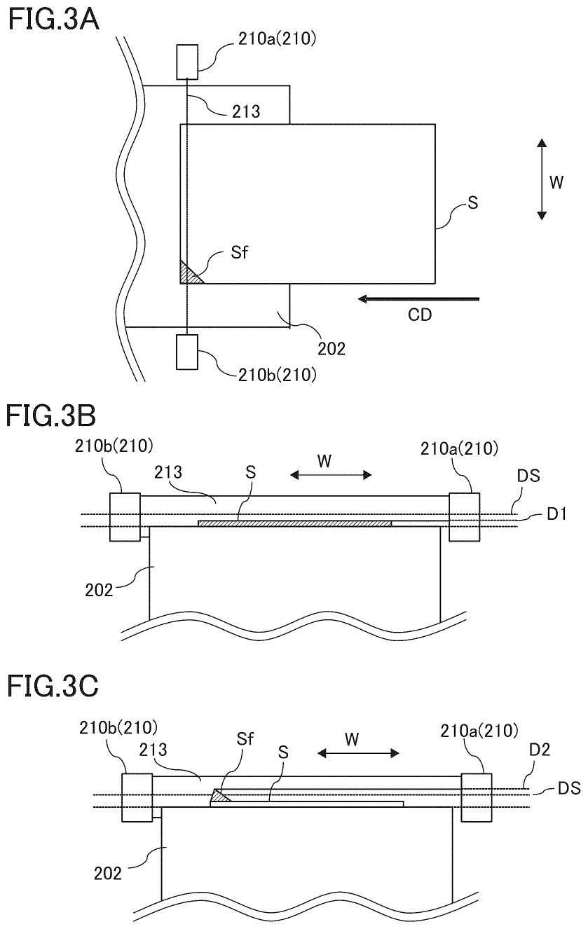

Next, a sheet floating error detected by the floating-state detection portion 210 will be described with reference to FIGS. 3A to 3C. FIG. 3A is a plan view illustrating the floating-state detection portion 210. FIG. 3B is a side view illustrating the floating-state detection portion 210 in a state where a normal sheet is being conveyed. FIG. 3C is a side view illustrating the floating-state detection portion 210 in a state where a floating sheet is being conveyed.

The sheet floating error indicates that a sheet has floated up from the print belt 202 to a position located above the print belt 202 and separated from the print belt 202 by a predetermined distance, at a position upstream of the ink-jet head 201 in the sheet conveyance direction. The sheet floating error can be detected by the floating-state detection portion 210.

As illustrated in FIGS. 2 and 3A, the floating-state detection portion 210 is constituted by a light emitting portion 210a and a light receiving portion 210b, and is disposed upstream of the image forming position of the ink-jet head 201 in a sheet conveyance direction CD. The light emitting portion 210a is disposed on one side of the print belt 202 in a width direction W orthogonal to the sheet conveyance direction CD. The light receiving portion 210b is disposed on the other side of the print belt 202 in the width direction W. In the light receiving portion 210b, light receiving elements are disposed in the vertical direction. If the light receiving portion 210b receives a line-shaped laser beam 213 emitted from the light emitting portion 210a, the light receiving portion 210b converts the laser beam 213 to an electrical signal and sends the electrical signal to an amplifier (not illustrated). By receiving the electrical signal, the amplifier measures what position of the light receiving elements, disposed in the light receiving portion 210b, has received the light or has not received the light.

As illustrated in FIG. 3B, in a case where a normal sheet S is conveyed by the print belt 202, light receiving elements below the position of the upper surface of the sheet are in a light-blocked state in the floating-state detection portion 210, and light receiving elements above the position of the upper surface of the sheet are in a light-receiving state. Thus, a light-blocked position D1 caused by the sheet S is determined as the position of the upper surface of the sheet, as a result of the measurement performed by the amplifier. The light-blocked position is a boundary position between a portion of the light receiving element array that has not received the light, and a portion of the light receiving element array that has received the light. Thus, the light-blocked position may be called a light-receiving position.

The amplifier has a detection threshold DS that is set in advance. Thus, if a measured light-blocked position is higher than the threshold DS, the floating-state detection portion 210 sends a signal to the outside for notifying the detection of a light blocking object. The threshold DS of the present embodiment is a value indicating that at least a portion of a light blocking object above the threshold DS may contact the ink-jet head 201 (the contact will be hereinafter referred to as head touch). The threshold DS is set appropriately in consideration of factors, such as a clearance between the print belt 202 and the ink-jet head 201, variations in size tolerance of components, and variations in parallelism between the laser beam 213 and the print belt 202.

In the present embodiment, if a light-blocked position above the threshold DS, caused by an object that has floated up from the print belt 202, is detected, the floating-state detection portion 210 sends a detection signal to the controller unit 1000. In an example illustrated in FIG. 3B, since the light-blocked position D1 is below the threshold DS, the detection signal is not sent to the controller unit 1000. Even if an object has floated up from the print belt 202, the object will not head touch as long as the floating-state detection portion 210 does not detect a light-blocked position above the threshold DS. In this case, the floating-state detection portion 210 does not send the detection signal to the controller unit 1000, so that a normal sheet conveyance operation and a normal image forming operation are continuously executed.

In an example illustrated in FIGS. 3A and 3C, a bent portion Sf is formed in a corner portion of the sheet S. In this case, the light-blocked position in the light receiving portion 210b of the floating-state detection portion 210 is measured as a light-blocked position D2 caused by the bent portion Sf of the sheet S. Since the light-blocked position D2 is above the threshold DS, the floating-state detection portion 210 sends the detection signal to the controller unit 1000. In the present embodiment, if the detection signal is sent to the controller unit 1000, the controller unit 1000 determines the sheet floating error. After that, the controller unit 1000 sends an instruction to the CPU 1001, and thereby stops the ejection of ink, and executes the escape discharge process for the sheet S, via the job management portion 1020. The escape discharge process for the sheet S will be described below.

In the example illustrated in FIGS. 3A and 3C, the bent portion Sf of the sheet S is formed on the left side in the figures. However, even if the floating up or deformation occurs in any portion of the sheet S in the width direction W of the print belt 202, or in the whole of the sheet S in the width direction W, the above-described escape discharge process is performed if a light-blocked position above the threshold DS is detected. That is, the floating-state detection portion 210 detects the floating of the sheet S. The deformation of the sheet S is not limited to bend, and may be of various states including curl and deflection.

By causing the floating-state detection portion 210 to detect the sheet floating error in this manner and executing the below-described escape discharge process, it is possible to suppress problems caused by the head touch. One of the problems is contamination of the ink-jet head 201. For example, if the sheet S collides with a recording head that is ejecting yellow (Y) ink, the Y ink adheres to the sheet S. After that, the sheet S may collide with a next-stage recording head that is ejecting magenta (M) ink. In this case, the Y ink adheres to the recording head that ejects the Mink. As a result, the ink in which the Mink and the Y ink are mixed with each other will be ejected to the sheet S, so that the normal image formation may not be performed.

In another problem, the ink-jet head 201 may be damaged. If the ink is ejected in a state where the sheet S is in contact with the ink-jet head 201, the ink ejection nozzle may be damaged, disabling the normal image formation.

Thus, for suppressing the above-described various problems, it is necessary to detect the head touch (or the sheet floating error) in advance, and after that, execute a process for preventing the head touch or a process for preventing the problems from occurring even if the head touch occurs. In the present embodiment, if the sheet floating error is detected by the floating-state detection portion 210, the CPU 1001 sends an instruction to the head control portion 1010, and thereby stops the ejection of ink, and executes the escape discharge process for the sheet S, via the job management portion 1020. With this operation, the above-described various problems can be suppressed.

### Size Disagreement Error

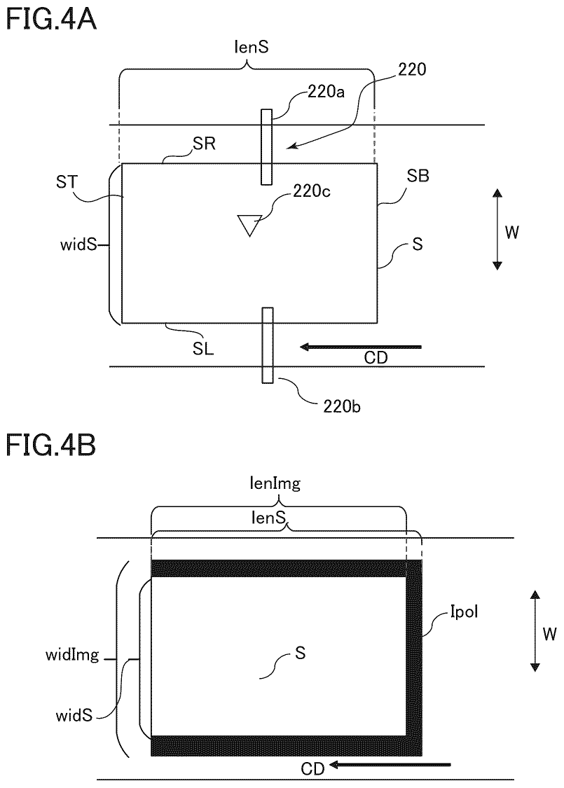

Next, a size disagreement error detected by the size detection portion 220 will be described with reference to FIGS. 4A and 4B. FIG. 4A is a plan view illustrating the size detection portion 220. FIG. 4B is a plan view illustrating a sheet size and an image size.

The size disagreement error indicates that the size of an image formed by the ink-jet head 201 and the size of a sheet detected by the size detection portion 220 do not match each other. The size disagreement error can be detected, based on the result detected by the size detection portion 220.

As illustrated in FIGS. 2 and 4A, the size detection portion 220 is disposed upstream of the image forming position of the ink-jet head 201 and the floating-state detection portion 210 in the sheet conveyance direction CD. The size detection portion 220 is constituted by image sensors 220a and 220b, and an edge detection sensor 200c. The image sensor 220a is a line sensor that can detect one edge SR of the sheet S in the width direction W, and the image sensor 220b is a line sensor that can detect another edge SL of the sheet S in the width direction W. The controller unit 1000 calculates a sheet width widS of the sheet S, based on the results detected by the image sensors 220a and 220b.

The edge detection sensor 200c is disposed between the image sensors 220a and 220b in the width direction W, and detects a leading edge ST and a trailing edge SB of the sheet S. In addition, the edge detection sensor 200c detects the time from when the leading edge ST is detected, until when the trailing edge SB is detected. The controller unit 1000 calculates a sheet length lenS that is the length of the sheet S in the sheet conveyance direction CD, based on the above-described time and the conveyance speed of the sheet S.

As illustrated in FIG. 4B, the size of an image (formed by the ink-jet head 201) in the width direction W is defined as an image width widImg, and the size of the image (formed by the ink-jet head 201) in the sheet conveyance direction CD is defined as an image length lenImg. The size detection portion 220 measures the sheet width widS and the sheet length lenS of the sheet S conveyed to the print portion 200, and compares the sheet width widS and the sheet length lenS with the image width widImg and the image length lenImg. Thus, the size detection portion 220 prevents, in advance, problems caused by the disagreement between the sheet size and the image size. One of the above-described problems is the contamination of ink produced in the print portion 200.

For example, in a case where an image is formed on an A4-size sheet S by the ink-jet head 201, a specified value of the image size is 205 mm in the image width widImg, and 287 mm in the image length lenImg. The specified value of the image size is set so that the image width is smaller than a width 210 mm in the international standard for the A4-size sheet, by a margin width of 5 mm, and that the image length is smaller than a length 297 mm in the international standard for the A4-size sheet, by a margin length of 10 mm.

For example, in a case where a sheet S that has varied in the cutting process and that has a sheet width widS of 200 mm and a sheet length lenS of 280 mm is conveyed to the print portion 200, the sheet size is smaller than the image size. In this case, as illustrated in FIG. 4B, the image protrudes from the sheet S, and the ink is ejected onto an area Ipol (coated with black in FIG. 4B). As a result, the print belt 202 will be contaminated with the ink, and the ink having adhered to the print belt 202 will adhere to a following sheet. In addition, the ink having adhered to the print belt 202 may cause the damage of the driving mechanism of the print belt 202 and the contamination of the image sensors of the size detection portion 220.

Thus, for suppressing the above-described various problems, it is necessary to detect the size disagreement error in advance, and after that, perform a process that suppresses the contamination of the print portion 200. In the present embodiment, the size detection portion 220 detects the size disagreement error in advance, and notifies the controller unit 1000 of the size disagreement error. After that, the CPU 1001 sends an instruction to the head control portion 1010, and thereby stops the ejection of ink, and executes the below-described escape discharge process for the sheet S, via the job management portion 1020.

In the present embodiment, in a case where the sheet size is smaller than the image size, the size disagreement error is detected. However, also in a case where the sheet size is larger than the image size, the size disagreement error may be detected, and the escape discharge process may be executed.

### Escape Discharge Process Performed When Sheet Floating Error or Size Disagreement Error is Detected

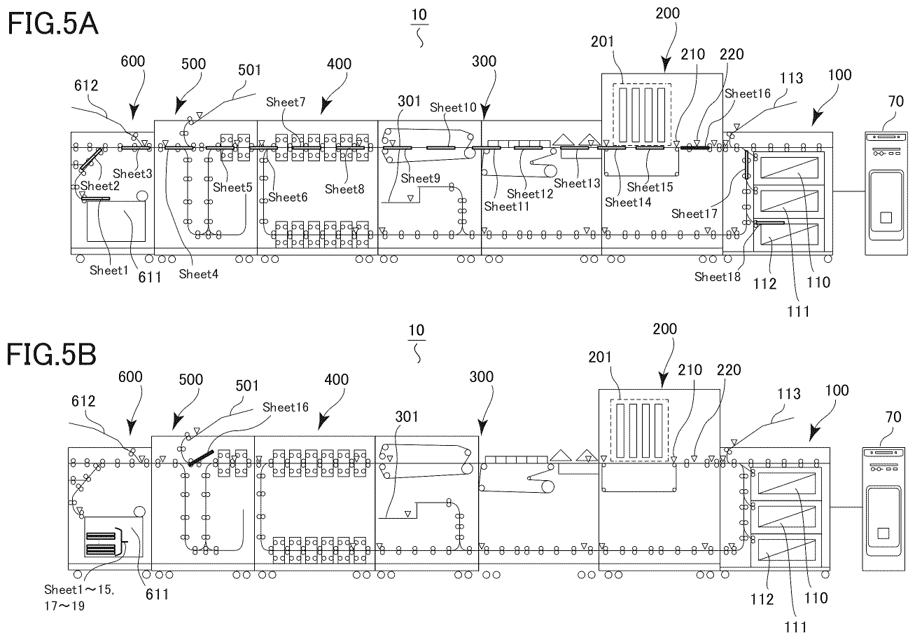

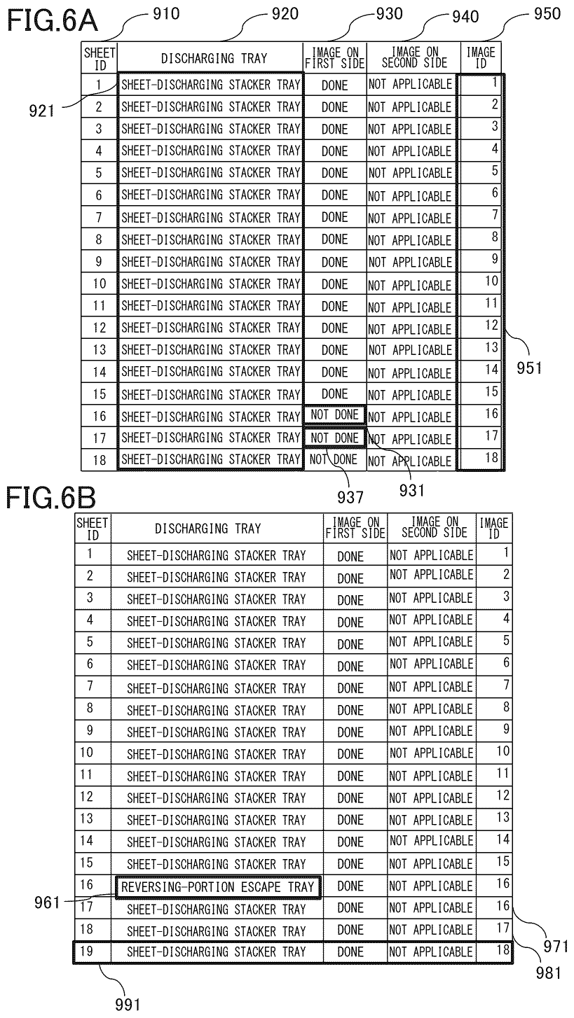

Next, the escape discharge process performed when the sheet floating error or the size disagreement error is detected will be described with reference to FIGS. 5A to 8B. FIG. 5A is a cross-sectional view illustrating a sheet conveyance state where a single-side 18-sheets job is being executed. FIG. 5B is a cross-sectional view illustrating a state where the single-side 18-sheets job is completed. The single-side 18-sheets job is a job in which the single-side printing is performed on 18 sheets. FIG. 6A is a diagram illustrating sheet information managed by the job management portion 1020 at a timing illustrated in FIG. 5A. FIG. 6B is a diagram illustrating sheet information managed by the job management portion 1020 at a timing illustrated in FIG. 5B.

First, an example of the escape discharge process performed in the single-side printing job will be described. As illustrated in FIG. 5A, the image forming apparatus 10 conveys 18 sheets while executing the single-side 18-sheets job. In the single-side 18-sheets job, the first sheet S conveyed in the image forming apparatus 10 is referred to as Sheet 1, and the 18-th sheet S conveyed in the image forming apparatus 10 is referred to as Sheet 18. That is, a sheet S is referred to as Sheet id that is one of Sheets 1 to 18.

In a state illustrated in FIG. 5A, Sheet 1 has reached the sheet-discharging stacker tray 611. In addition, in FIG. 5A, a corner of Sheet 16 is bent, and is in a state immediately before Sheet 16 is detected, as an abnormal sheet, by the floating-state detection portion 210.

As illustrated in FIG. 6A, the sheet information managed by the job management portion 1020 includes a Sheet-id column 910, a discharge-tray column 920, an image-on-first-side column 930, an image-on-second-side column 940, and an image-id column 950. The Sheet-id column 910 indicates an ID number of each of Sheets 1 to 18. The discharge-tray column 920 indicates a tray to which each of Sheets 1 to 18 is discharged. The image-on-first-side column 930 indicates whether an image has been formed on the first side of each sheet. The image-on-second-side column 940 indicates whether an image has been formed on the second side of each sheet. In each of the image-on-first-side column 930 and the image-on-second-side column 940, the information of “done” is stored if the formation of an image has been started, and the information of “not done” is stored if the formation of an image has not yet been started. In the single-side printing job, since the image formation is not performed on the second side of each sheet, the information of “not applicable” is stored in the image-on-second-side column 940. The image-id column 950 stores an id of an image formed on each sheet.

As illustrated in an area 921 of FIG. 6A, in a state where the sheet floating error or the size disagreement error has not yet been detected, all of Sheets 1 to 18 are discharged to the sheet-discharging stacker tray 611. In addition, as illustrated in an area 951 of FIG. 6A, the number of each image id stored in the image-id column 950 is equal to the number of a corresponding sheet id.

If the sheet floating error of Sheet 16 illustrated in FIG. 5A is detected by the floating-state detection portion 210, the ink-jet head 201 cancels the ink ejection performed on Sheet 16. In addition, as illustrated in FIG. 6B, a parameter 961 of the discharge-tray column 920 for Sheet 16 is changed so as to indicate the reversing-portion escape tray 501. Furthermore, the image replacement process is performed on Sheet 17 and the sheets following Sheet 17. Specifically, a parameter 971 of the image-id column 950 for Sheet 17 is replaced with 16, and a parameter 981 of the image-id column 950 for Sheet 18 is replaced with 17. Furthermore, Sheet 19 provided with a parameter of 18 in the image-id column 950 is fed additionally.

After that, the escape discharge process is executed based on the sheet information illustrated in FIG. 6B and managed by the job management portion 1020, so that only Sheet 16 is discharged to the reversing-portion escape tray 501. In this case, Sheets 1 to 15, and 17 to 19 are discharged to the sheet-discharging stacker tray 611.

Note that if a parameter 937 of the image-on-first-side column 930 for Sheet 17 is not “not done” but “done” at a point of time at which Sheet 16 is determined as an abnormal sheet, the image replacement for Sheet 17 will not be performed in time. Thus, Sheet 17 is also discharged to the reversing-portion escape tray 501, and the parameter of the image-id column 950 for Sheet 18 is replaced with 16. Furthermore, Sheet 19 on which an image having an image id 17 is to be printed, and Sheet 20 on which an image having an image id 18 is to be printed are fed additionally.

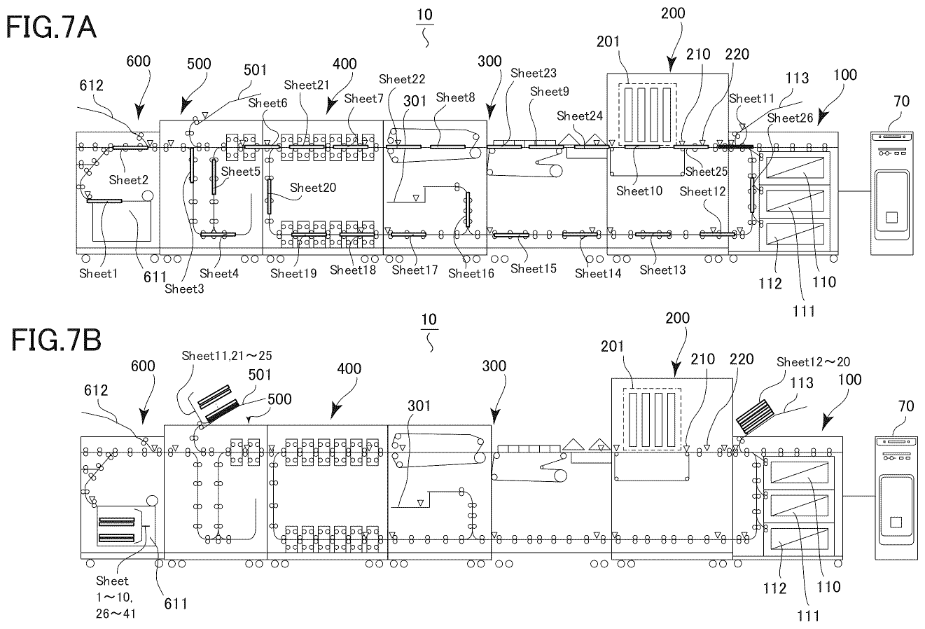

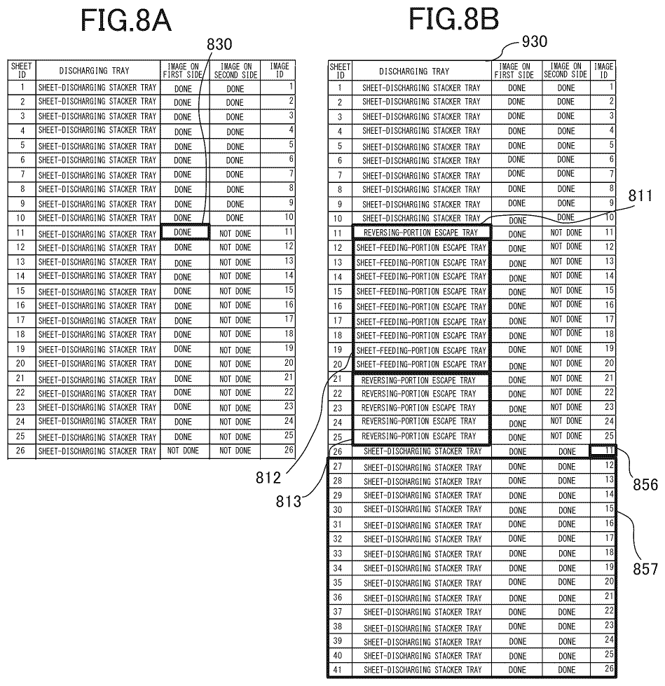

Next, an example of the escape discharge process performed in the double-side printing job will be described. FIG. 7A is a cross-sectional view illustrating a sheet conveyance state where a double-side 26-sheets job is being executed. FIG. 7B is a cross-sectional view illustrating a state where the double-side 26-sheets job is completed. The double-side 26-sheets job is a job in which the double-side printing is performed on 26 sheets. FIG. 8A is a diagram illustrating sheet information managed by the job management portion 1020 at a timing illustrated in FIG. 7A. FIG. 8B is a diagram illustrating sheet information managed by the job management portion 1020 at a timing illustrated in FIG. 7B.

As illustrated in FIG. 7A, the image forming apparatus 10 conveys 26 sheets while executing the double-side 26-sheets job. In the double-side 26-sheets job, the first sheet S conveyed in the image forming apparatus 10 is referred to as Sheet 1, and the 26-th sheet S conveyed in the image forming apparatus 10 is referred to as Sheet 26. That is, a sheet S is referred to as Sheet id that is one of Sheets 1 to 26.

In a state illustrated in FIG. 7A, Sheet 1 has reached the sheet-discharging stacker tray 611. In addition, in FIG. 7A, a corner of Sheet 11 is bent, and is in a state immediately before Sheet 11 is detected, as an abnormal sheet, by the floating-state detection portion 210. In this state, as illustrated in FIG. 8A, in the sheet information managed by the job management portion 1020, a parameter 830 of the image-on-first-side column 930 for Sheet 11 is “done”.

If the sheet floating error of Sheet 11 illustrated in FIG. 7A is detected by the floating-state detection portion 210, the ink-jet head 201 cancels the ink ejection performed on Sheet 11. In addition, as illustrated in FIG. 8B, a parameter 811 of the discharge-tray column 920 for Sheet 11 is changed so as to indicate the reversing-portion escape tray 501. Furthermore, for keeping the order of the image id, all the sheets following Sheet 11 whose parameter in the image-on-first-side column 930 is “done” are regarded as abnormal sheets.

The ink ejection on the abnormal sheets are canceled. Then, the escape discharge process is performed on Sheets 12 to 25. As illustrated in FIG. 8B, a parameter 812 of the discharge-tray column 920 for Sheets 12 to 20 is changed so as to indicate the sheet-feeding-portion escape tray 113. In addition, a parameter 813 of the discharge-tray column 920 for Sheets 21 to 25 is changed so as to indicate the reversing-portion escape tray 501.

The parameter of the discharge-tray column 920 is determined, depending on where the sheet is located in the conveyance path. The job management portion 1020 calculates positions of all the sheets located in the conveyance path, using the time that has elapsed since the start of feeding each sheet. The relationship between the conveyance path and the escape discharge tray that is set in the escape discharge process will be described below.

In addition, the image replacement process is executed on Sheet 26, so that a parameter 856 of the image-id column 950 for Sheet 26 is replaced with 11. Furthermore, as illustrated in an area 857, Sheets 27 to 41 provided with parameters of 12 to 26 in the image-id column 950 are fed additionally.

Note that in FIGS. 5A to 8B, the description has been made for the escape discharge process performed when the sheet floating error is detected. However, the escape discharge process is also performed in the same manner when the size disagreement error is detected.

### Escape Discharge Process Performed When Jam is Detected

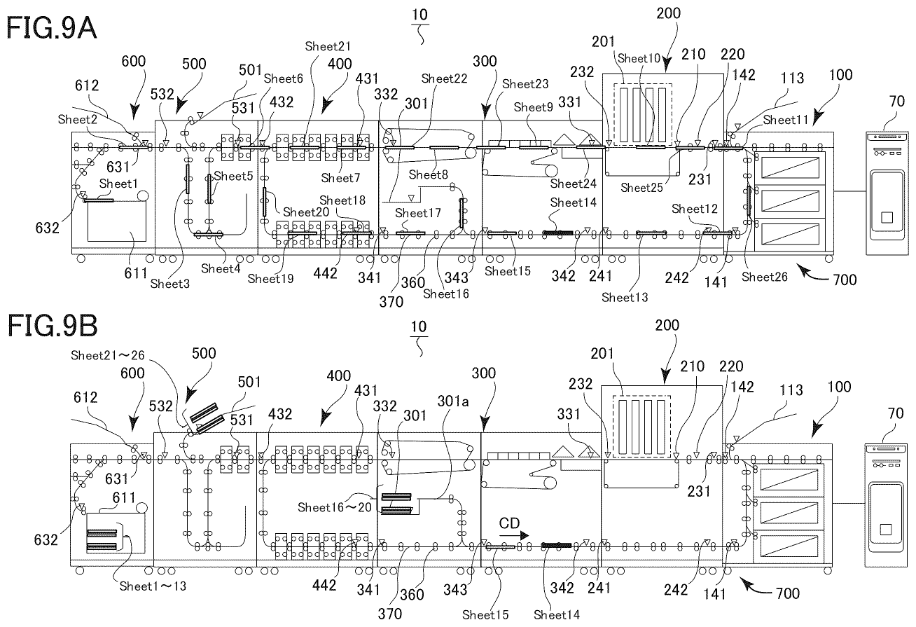

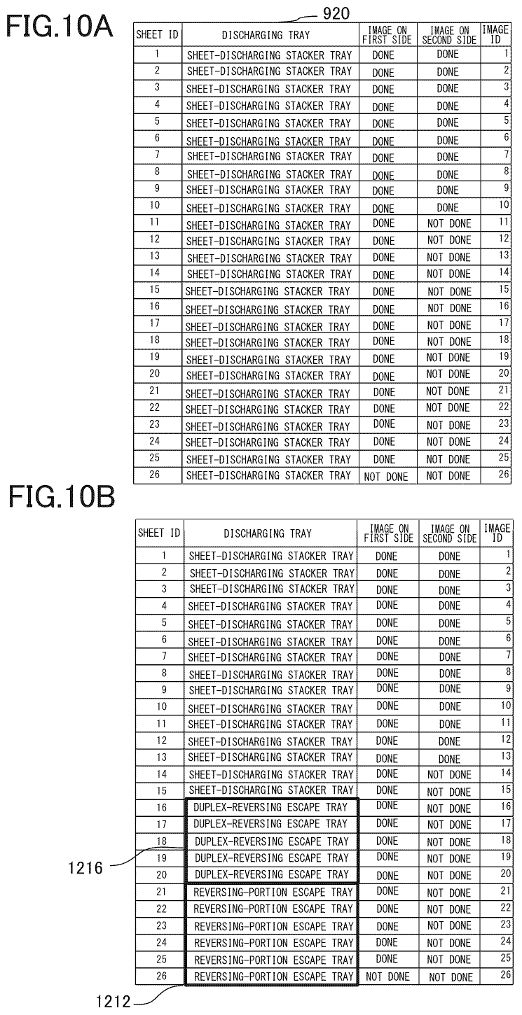

Next, an escape discharge process performed when a jam of a sheet is detected will be described with reference to FIGS. 9A to 10B. FIG. 9A is a cross-sectional view illustrating a sheet conveyance state where the double-side 26-sheets job is being executed. FIG. 9B is a cross-sectional view illustrating a state where the escape discharge process is completed after a jam is detected. FIG. 10A is a diagram illustrating sheet information managed by the job management portion 1020 at a timing illustrated in FIG. 9A. FIG. 10B is a diagram illustrating sheet information managed by the job management portion 1020 at a timing illustrated in FIG. 9B.

As illustrated in FIG. 9A, in the conveyance path of the image forming apparatus 10, the conveyance-path sensors 141, 142, 231, 232, 241, 242, 331, 332, 341, 342, 343, 431, 432, 442, 531, 532, 631, and 632 are disposed as sheet sensors. The CPU 1001 can detect the timing at which a sheet passes each conveyance-path sensor, depending on a signal from the conveyance-path sensor. Note that the conveyance-path sensors 141, 142, 231, 232, 241, 242, 331, 332, 341, 342, 343, 431, 432, 442, 531, 532, 631, and 632, the floating-state detection portion 210, and the size detection portion 220 constitute an error detection portion 700 that detects below-described first error and second error.

As illustrated in FIG. 10A, in the sheet information managed by the job management portion 1020 and obtained before a jam is detected, the parameters of the discharge-tray column 920 for all the Sheets 1 to 26 indicate the sheet-discharging stacker tray 611. Hereinafter, the description will be made, as an example, for a case where Sheet 14 on which the single-side printing has been performed is jammed at a position immediately in front of the conveyance-path sensor 342.

If the time from when Sheet 14 passes the conveyance-path sensor 343, until when Sheet 14 passes the conveyance-path sensor 342 exceeds a predetermined time, the CPU 1001 determines that a jam has occurred because Sheet 14 has not been conveyed normally. The conveyance of Sheet 14 that has caused the jam is stopped. In this example, a conveyance path 301a that extends toward the duplex-reversing escape tray 301 is disposed upstream of the jam occurrence position in the sheet conveyance direction CD. Thus, even if the conveyance of Sheet 14 is stopped, it is possible to discharge Sheets 16 to 20 to the duplex-reversing escape tray 301 via the conveyance path 301a. Note that since Sheet 15 is located downstream of the conveyance path 301a in the sheet conveyance direction CD, it is not possible to discharge Sheet 15 to the duplex-reversing escape tray 301. Thus, the conveyance of Sheet 15 is stopped.

As illustrated in FIG. 10B, if the jam of Sheet 14 is detected, all the sheets following Sheet 14 are regarded as abnormal sheets. Since the conveyance of Sheet 15 is stopped as described above, the parameters of the discharge-tray column 920 for Sheets 16 to 26 are changed, as illustrated in areas 1216 and 1212. Specifically, parameters of the discharge-tray column 920 for Sheets 16 to 20 are changed so as to indicate the duplex-reversing escape tray 301. In addition, parameters of the discharge-tray column 920 for Sheets 21 to 26 are changed so as to indicate the reversing-portion escape tray 501. The parameter of the discharge-tray column 920 is determined, depending on where the sheet is located in the conveyance path. The job management portion 1020 calculates positions of all the sheets located in the conveyance path, using the time that has elapsed since the feeding of each sheet. The relationship between the conveyance path and the escape discharge tray that is set in the escape discharge process will be described below.

If all the sheets left in the image forming apparatus 10 and all the sheets stacked on the duplex-reversing escape tray 301 are removed, the error on the jam is cleared, and the print job is restarted. Whether all the sheets left in the image forming apparatus 10 are removed is determined, based on the result detected by each conveyance-path sensor. In addition, whether all the sheets stacked on the duplex-reversing escape tray 301 are removed is determined, based on the result detected by the duplex-reversing escape tray sensor 320.

### Access to Each Escape Tray

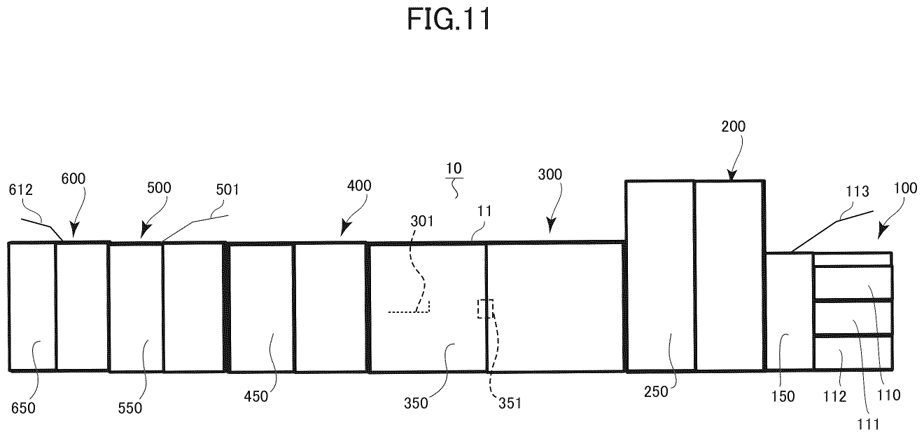

Next, accessibility to each escape tray will be described with reference to FIG. 11. FIG. 11 is a front view illustrating the image forming apparatus 10. As illustrated in FIG. 11, the sheet feeding portion 100 includes a sheet-feeding-portion door 150 that can be opened and closed. The sheet-feeding-portion door 150 covers the conveyance path of the sheet feeding portion 100 in a state where the sheet-feeding-portion door 150 is closed. The print portion 200 includes a print-portion door 250 that can be opened and closed. The print-portion door 250 covers the conveyance path of the print portion 200 in a state where the print-portion door 250 is closed. The fixing portion 300 includes a fixing-portion door 350 that can be opened and closed. The fixing-portion door 350 that serves as a door portion covers the conveyance path of the fixing portion 300 in a state where the fixing-portion door 350 is closed.

The cooling portion 400 includes a cooling-portion door 450 that can be opened and closed. The cooling-portion door 450 covers the conveyance path of the cooling portion 400 in a state where the cooling-portion door 450 is closed. The reversing portion 500 includes a reversing-portion door 550 that can be opened and closed. The reversing-portion door 550 covers the conveyance path of the reversing portion 500 in a state where the reversing-portion door 550 is closed. The discharging portion 600 includes a discharging-portion door 650 that can be opened and closed. The discharging-portion door 650 covers the conveyance path of the discharging portion 600 in a state where the discharging-portion door 650 is closed.

These doors can be locked by lock mechanisms (not illustrated) in a state where the doors are closed. While the image forming apparatus 10 performs the image forming operation, the CPU 1001 controls the lock mechanisms so that each door is locked. For example, the fixing portion 300 includes a lock mechanism 351 that locks the fixing-portion door 350, and the fixing-portion door 350 is openably and closably supported by a casing 11 of the image forming apparatus 10. While the image forming operation is performed, the lock mechanism 351 locks the fixing-portion door 350 on the casing 11 in a state where the fixing-portion door 350 is closed with respect to the casing 11. Note that each door may not be a single door member, and may be constituted by a plurality of door members. For example, the fixing-portion door 350 may be constituted by two door members that can be opened from the center of the two door members.

The sheet-feeding-portion escape tray 113 is disposed on a top surface of the sheet feeding portion 100. Thus, the sheets discharged to the sheet-feeding-portion escape tray 113 can be removed without opening the sheet-feeding-portion door 150. In addition, the reversing-portion escape tray 501 is disposed on a top surface of the reversing portion 500. Thus, the sheets discharged to the reversing-portion escape tray 501 can be removed without opening the reversing-portion door 550. In other words, the sheet-feeding-portion escape tray 113 and the reversing-portion escape tray 501 are disposed in an open space, and arranged so as to be exposed to the outside of the casing 11 of the image forming apparatus 10.

In contrast, the duplex-reversing escape tray 301 cannot be accessed unless the fixing-portion door 350 is opened. That is, the duplex-reversing escape tray 301 is disposed inside the casing 11. Thus, the sheets discharged to the duplex-reversing escape tray 301 are removed after the fixing-portion door 350 is opened. In other words, the duplex-reversing escape tray 301 is disposed so as not to be exposed to the outside of the casing 11 of the image forming apparatus 10. Since the fixing-portion door 350 is locked by the lock mechanism 351 in the image forming operation, the duplex-reversing escape tray 301 can be accessed only while the image forming operation is stopped due to the jam or the like, or a print job is not received by the image forming apparatus 10.

### Tray Used in Escape Discharge Process

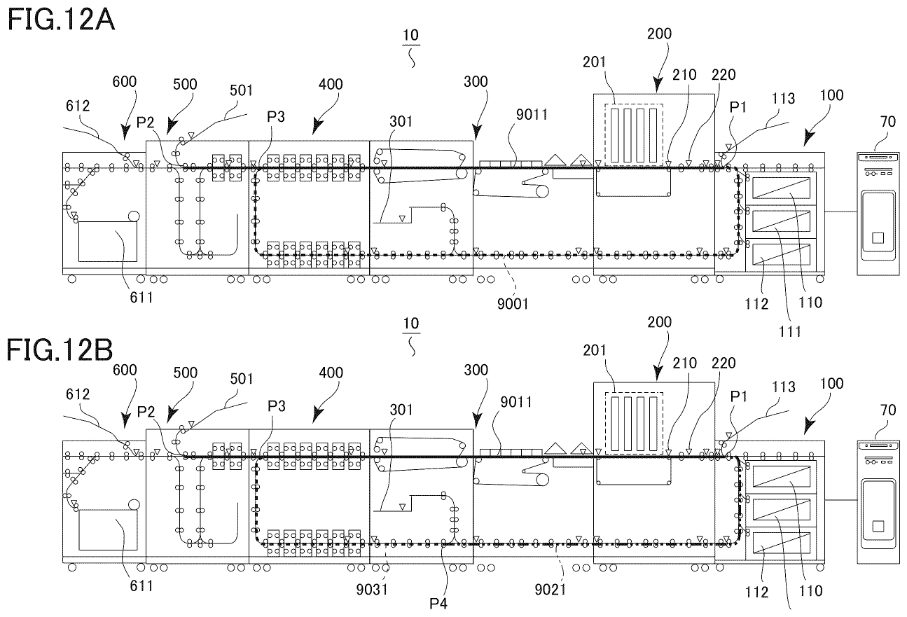

As described above, the job management portion 1020 determines a tray (i.e., an escape discharge tray) to which a sheet is discharged, based on the position of the sheet in the image forming apparatus 10. Next, the relationship between the sheet position and the above-described escape discharge tray will be described with reference to FIGS. 12A and 12B. Note that in the following description, an error, such as the sheet floating error or the size disagreement error, that allows the image forming operation to continue is referred to as a first error. In addition, an error, such as the jam, that does not allow the image forming operation to continue is referred to as a second error.

FIG. 12A is a diagram illustrating the relationship between the sheet position and the escape discharge tray in the escape discharge process for resuming the image forming operation from the first error. FIG. 12B is a diagram illustrating the relationship between the sheet position and the escape discharge tray in the escape discharge process for resuming the image forming operation from the second error.

After the first error is detected, the escape discharge process is executed, so that the image forming operation is resumed from the first error without a user performing the recovery process. Thus, the job is restarted. That is, in a case where the first error is detected, the controller unit 1000 causes the image forming portion 201 to continue the image forming operation while executing a first recovery operation. As illustrated in FIG. 12A, a conveyance path 9011 is a conveyance path that extends from a branch point P1 extending to the sheet-feeding-portion escape tray 113, to a branch point P2 extending to the reversing-portion escape tray 501. The job management portion 1020 sets the reversing-portion escape tray 501 as the escape discharge tray for an abnormal sheet located in the conveyance path 9011 and having the first error.

In addition, a conveyance path 9001 is a conveyance path that extends from a branch point P3 at which the duplex conveyance path branches from the conveyance path 9011, to the branch point P1. The job management portion 1020 sets the sheet-feeding-portion escape tray 113 as the escape discharge tray for an abnormal sheet located in the conveyance path 9001 and having the first error.

Since the floating-state detection portion 210 and the size detection portion 220 are disposed on the conveyance path 9011, an error sheet whose sheet floating has been detected by the floating-state detection portion 210 is discharged to the reversing-portion escape tray 501. In addition, a sheet that is regarded as an abnormal sheet because the image replacement will not be performed on the sheet in time, or sheets following an error sheet (i.e., an abnormal sheet) are discharged to the reversing-portion escape tray 501 or the sheet-feeding-portion escape tray 113 for keeping the order of the image id. The duplex-reversing escape tray 301 is not set as the escape discharge tray, for any abnormal sheet having the first error.

On the other hand, after the second error is detected, it is necessary for a user to perform a recovery process, such as manual removing of sheets, for removing the sheets left in the image forming apparatus 10. That is, in a case where the second error is detected, the controller unit 1000 causes the image forming portion 201 to stop the image forming operation until the second error is cleared. After such a recovery process is performed, the job is restarted. A conveyance path 9031 is a conveyance path that extends from the branch point P3 to a branch point P4 extending to the duplex-reversing escape tray 301. As illustrated in FIG. 12B, the job management portion 1020 sets the duplex-reversing escape tray 301 as the escape discharge tray for an abnormal sheet located in the conveyance path 9031 and having the second error. In addition, the job management portion 1020 sets the sheet-feeding-portion escape tray 113 as the escape discharge tray for an abnormal sheet located in a conveyance path 9021 from the branch point P4 to the branch point P1 and having the second error. In addition, the job management portion 1020 sets the reversing-portion escape tray 501 as the escape discharge tray for an abnormal sheet located in the conveyance path 9011 and having the second error. That is, in a case where the second error is detected on a first sheet, the controller unit 1000 executes a second recovery operation. In the second recovery operation, the controller unit 1000 determines which of the sheet-feeding-portion escape tray 113, the reversing-portion escape tray 501, and the duplex-reversing escape tray 301 the controller unit 1000 discharges a second sheet to, depending on the position of the second sheet different from the first sheet left in the conveyance path.

As described above, the sheet-feeding-portion escape tray 113 and the reversing-portion escape tray 501 can be accessed not via the respective doors. In contrast, the duplex-reversing escape tray 301 can be accessed only after the fixing-portion door 350 locked in the image forming operation is opened. Thus, the sheets stacked on the duplex-reversing escape tray 301 can be removed only while the image forming operation is stopped due to a jam or the like.

In the present embodiment, in a case where the first error, which allows the image forming operation to continue without stopping the image forming operation, occurs, the sheet-feeding-portion escape tray 113 or the reversing-portion escape tray 501 is set as the escape discharge tray for each sheet. Thus, if the sheets discharged to the sheet-feeding-portion escape tray 113 and the reversing-portion escape tray 501 are removed by a user, sheets are not fully stacked on the sheet-feeding-portion escape tray 113 and the reversing-portion escape tray 501. As a result, the job can be continued without stopping the image forming operation, so that the productivity can be increased.

In addition, in a case where the second error, which does not allow the image forming operation to continue, occurs, the duplex-reversing escape tray 301 can also be set as the escape discharge tray for each sheet, in addition to the sheet-feeding-portion escape tray 113 and the reversing-portion escape tray 501. Thus, the number of sheets left in the image forming apparatus 10 when a jam occurs can be decreased, the load for a user to perform a manual recovery process can be decreased, and the usability can be increased.

In the present embodiment, 60 sheets can be stacked on the duplex-reversing escape tray 301 for allowing all the sheets conveyed in the image forming apparatus 10 to be stacked on the duplex-reversing escape tray 301. Since the duplex-reversing escape tray 301 is used only when the second error, such as a jam, occurs, the detection for fully stacked sheets is not performed on the duplex-reversing escape tray 301. This is because the sheets are removed from the duplex-reversing escape tray 301 by a user when the jam is handled.

On the other hand, 500 sheets can be stacked on each of the sheet-feeding-portion escape tray 113 and the reversing-portion escape tray 501. This is because each of the sheet-feeding-portion escape tray 113 and the reversing-portion escape tray 501 is used as the escape discharge tray for sheets having the first error that occurs at a certain rate. That is, the number of sheets that can be stacked on each of the sheet-feeding-portion escape tray 113 and the reversing-portion escape tray 501, each of which serves as a first stacking portion, is larger than the number of sheets that can be stacked on the duplex-reversing escape tray 301, which serves as a second stacking portion.

After each sheet on the sheet-feeding-portion escape tray 113 is detected by the sheet-feeding-portion escape tray sensor 120, the CPU 1001 counts the sheet discharged to the sheet-feeding-portion escape tray 113. If the number of counted sheets exceeds the number (e.g., 500) of sheets that can be stacked on the sheet-feeding-portion escape tray 113, the CPU 1001 determines that sheets are fully stacked on the sheet-feeding-portion escape tray 113. If the sheet-feeding-portion escape tray sensor 120 detects that the sheets stacked on the sheet-feeding-portion escape tray 113 have been removed, the CPU 1001 resets the number of counted sheets, and resets the determination that sheets are fully stacked on the sheet-feeding-portion escape tray 113.

Similarly, after each sheet on the reversing-portion escape tray 501 is detected by the reversing-portion escape tray sensor 520, the CPU 1001 counts the sheet discharged to the reversing-portion escape tray 501. If the number of counted sheets exceeds the number (e.g., 500) of sheets that can be stacked on the reversing-portion escape tray 501, the CPU 1001 determines that sheets are fully stacked on the reversing-portion escape tray 501. If the reversing-portion escape tray sensor 520 detects that the sheets stacked on the reversing-portion escape tray 501 have been removed, the CPU 1001 resets the number of counted sheets, and resets the determination that sheets are fully stacked on the reversing-portion escape tray 501.

### Flow of Escape Discharge Process

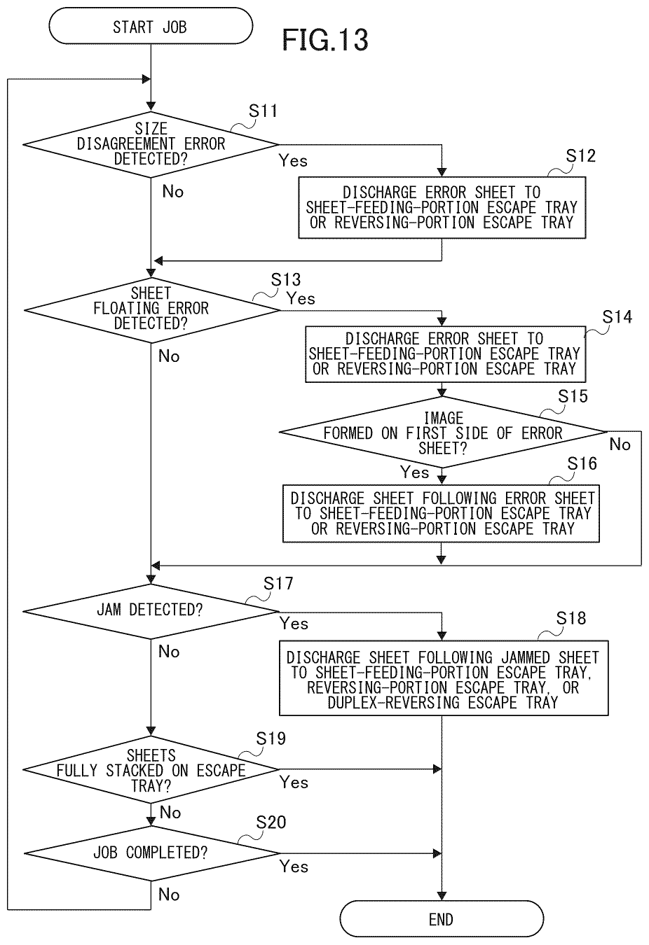

Next, a flow of the escape discharge process performed by the controller unit 1000 will be described in detail with reference to FIG. 13. The escape discharge process is a process for discharging an abnormal sheet to an escape discharge tray that is set for resuming the image forming operation from an error in a case where the first error or the second error is detected. FIG. 13 is a flowchart illustrating the escape discharge process. The determination in the flowchart and the switch of the sheet discharging tray (i.e., the escape discharge tray) are performed by the CPU 1001 and the job management portion 1020, and the conveyance control for the sheet is performed by the conveyance control portion 1011. In the following description, the control in the flowchart is performed mainly by the controller unit 1000.

As illustrated in FIG. 13, if a print job is started, the controller unit 1000 determines whether the size disagreement error has been detected by the size detection portion 220 (Step S11). If the size disagreement error has not been detected by the size detection portion 220 (Step S11: No), then the controller unit 1000 proceeds to Step S13. If the size disagreement error has been detected (Step S11: Yes), then the controller unit 1000 discharges an error sheet and a following sheet to the sheet-feeding-portion escape tray 113 or the reversing-portion escape tray 501 (Step S12). The error sheet is a sheet on which the size disagreement error has been detected, and the following sheet is a sheet on which the image replacement will not be performed in time.

Note that in the present embodiment, the detection for the size disagreement error is performed only one time on a sheet. Thus, in the double-side printing, although the sheet S passes though the conveyance path twice on which the size detection portion 220 is disposed, the size detection portion 220 does not detect the size of the sheet S immediately before an image is formed on the second side of the sheet S.

After Steps S11 and S12, the controller unit 1000 determines whether the sheet floating error has been detected by the floating-state detection portion 210 (Step S13). If the sheet floating error has not been detected (Step S13: No), then the controller unit 1000 proceeds to Step S17.

If the sheet floating error has been detected (Step S13: Yes), then the controller unit 1000 discharges an error sheet and a following sheet to the sheet-feeding-portion escape tray 113 or the reversing-portion escape tray 501 (Step S14). The error sheet is a sheet on which the sheet floating error has been detected, and the following sheet is a sheet on which the image replacement will not be performed in time. Then the controller unit 1000 determines whether an image is formed on the first side of the error sheet (Step S15). If the image is not formed on the first side of the error sheet (Step S15: No), then the controller unit 1000 proceeds to Step S17. If the image is formed on the first side of the error sheet (Step S15: Yes), then the controller unit 1000 discharges all the sheets following the error sheet (on which first side an image is formed), to the sheet-feeding-portion escape tray 113 or the reversing-portion escape tray 501 for keeping the order of the image id (Step S16).

For example, an error sheet on which the sheet floating error has been detected is referred to as a first sheet, and a sheet which follows the first sheet is referred to as a second sheet. In a case where the second sheet, the duplex-reversing escape tray 301, and the sheet-feeding-portion escape tray 113 are disposed in this order in the sheet conveyance direction CD, the first sheet is discharged to the reversing-portion escape tray 501. In this case, the second sheet is not discharged to the duplex-reversing escape tray 301, but discharged to the sheet-feeding-portion escape tray 113. That is, although the duplex-reversing escape tray 301 is a tray closest to the second sheet in the sheet conveyance direction CD, the second sheet is not discharged to the duplex-reversing escape tray 301.

Then the controller unit 1000 determines whether a jam has been detected by each conveyance-path sensor (Step S17). In a case where the jam has been detected (Step S17: Yes), if the conveyance path 301a extending toward the duplex-reversing escape tray 301 is located upstream of the jam occurrence position in the sheet conveyance direction CD, the controller unit 1000 perform the following operation. That is, the controller unit 1000 discharges a sheet following a jammed sheet has caused the jam, to the sheet-feeding-portion escape tray 113, the reversing-portion escape tray 501, or the duplex-reversing escape tray 301 (Step S18). Then the controller unit 1000 ends the escape discharge process.

If the jam has not been detected (Step S17: No), then the controller unit 1000 determines whether sheets are fully stacked on the sheet-feeding-portion escape tray 113 or the reversing-portion escape tray 501 (Step S19). If the controller unit 1000 determines that sheets are fully stacked on the sheet-feeding-portion escape tray 113 or the reversing-portion escape tray 501 (Step S19: Yes), then the controller unit 1000 ends the job.

If the controller unit 1000 determines that sheets are not fully stacked on the sheet-feeding-portion escape tray 113 or the reversing-portion escape tray 501 (Step S19: No), then the controller unit 1000 determines whether the job has been ended (Step S20). If the controller unit 1000 determines that the job has not been ended (Step S20: No), then the controller unit 1000 returns to Step S11. If the controller unit 1000 determines that the job has been ended (Step S20: Yes), then the controller unit 1000 ends the flow.

As described above, in the present embodiment, in a case where the first error, such as the sheet floating error or the size disagreement error, that allows the image forming operation to continue without stopping the image forming operation occurs, the escape discharge process is executed as a first recovery operation, which is executed to recover from the first error. In the escape discharge process, each of the conveyance roller pairs is controlled so that sheets are discharged only to the sheet-feeding-portion escape tray 113 or the reversing-portion escape tray 501 that can be accessed by a user in the image forming operation, and that the sheets are not discharged to the duplex-reversing escape tray 301. Thus, the job can be continued unless sheets are fully stacked on the sheet-feeding-portion escape tray 113 or the reversing-portion escape tray 501 after sheets are removed from the sheet-feeding-portion escape tray 113 or the reversing-portion escape tray 501. As a result, the productivity can be increased.

On the other hand, in a case where the second error, such as a jam, that does not allow the image forming operation to continue occurs, the escape discharge process is executed as the second recovery operation, which is executed to recover from the second error. In the escape discharge process, in addition to the sheet-feeding-portion escape tray 113 and the reversing-portion escape tray 501, sheets can be discharged also to the duplex-reversing escape tray 301 that can be accessed only while the image forming operation is stopped. In other words, each of the conveyance roller pairs is controlled so that sheets are discharged to at least one of the sheet-feeding-portion escape tray 113, the reversing-portion escape tray 501, and the duplex-reversing escape tray 301. Thus, the number of sheets left in the image forming apparatus 10 can be decreased, the load for a user to perform a manual recovery process can be decreased, and the usability can be increased.

### Other Embodiments

Note that in the present embodiment, each of the sheet-feeding-portion escape tray 113 and the reversing-portion escape tray 501 is disposed as the first stacking portion. However, only one of the sheet-feeding-portion escape tray 113 and the reversing-portion escape tray 501 may be disposed as the first stacking portion. In addition, the escape discharge tray, which is used in the escape discharge process executed for resuming the image forming operation from the first error or the second error, may be disposed in any position. For example, instead of the duplex-reversing escape tray 301, an escape discharge tray may be disposed in a position covered by the print-portion door 250, or a position covered by the cooling-portion door 450, and sheets may be discharged to the escape discharge tray in the escape discharge process executed for resuming the image forming process from the first error.

In addition, in any of the above-described embodiments, the description has been made for the ink-jet image forming apparatus 10 that forms an image on a sheet by ejecting ink liquid from a nozzle. However, the present invention is not limited to this. For example, the present invention may also be applied to an electrophotographic image forming apparatus.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-047365, filed Mar. 22, 2024, which is hereby incorporated by reference herein in its entirety.

What is claimed is:

1. An image forming apparatus comprising:
a casing;
an image forming portion configured to execute an image forming operation that forms an image on a sheet;
a door portion openably and closably supported by the casing;
a first stacking portion which is disposed so as to be exposed to an outside of the casing, and on which a sheet is stacked;
a second stacking portion which is disposed in the casing so as not to be exposed to the outside of the casing in a state where the door portion is closed with respect to the casing, and on which a sheet is stacked;
a conveyance portion configured to convey a sheet;
an error detection portion configured to detect a first error and a second error, the first error being an error that allows the image forming operation to continue, the second error being an error that does not allow the image forming operation to continue; and
a control portion configured to control the conveyance portion,
wherein the control portion is configured to execute
(i) a first recovery operation in a case where the first error is detected by the error detection portion, the first recovery operation being an operation that is executed to recover from the first error, and that controls the conveyance portion to discharge a sheet to the first stacking portion and not to discharge a sheet to the second stacking portion, and
(ii) a second recovery operation in a case where the second error is detected by the error detection portion, the second recovery operation being an operation that is executed to recover from the second error, and that controls the conveyance portion to discharge a sheet to at least one of the first stacking portion and the second stacking portion.

2. The image forming apparatus according to claim 1, wherein in a case where the first error is detected on a first sheet by the error detection portion, the control portion controls, in the first recovery operation, the conveyance portion to discharge the first sheet and a second sheet following the first sheet to the first stacking portion, and not to discharge the first sheet and the second sheet to the second stacking portion.

3. The image forming apparatus according to claim 1, wherein in a case where the first error is detected on a first sheet by the error detection portion, if a second sheet following the first sheet, the second stacking portion, and the first stacking portion are disposed in this order in a sheet conveyance direction, the control portion controls, in the first recovery operation, the conveyance portion not to discharge the second sheet to the second stacking portion, and to discharge the second sheet to the first stacking portion.

4. The image forming apparatus according to claim 1, wherein the error detection portion includes a floating-state detection portion disposed upstream of an image forming position in a sheet conveyance direction and configured to detect floating of a sheet, the image forming position being a position at which the image forming portion forms an image on a sheet, and
wherein the control portion executes the first recovery operation in a case where floating of a sheet is detected as the first error by the floating-state detection portion.

5. The image forming apparatus according to claim 1, wherein the error detection portion includes a size detection portion disposed upstream of an image forming position in a sheet conveyance direction and configured to detect a size of a sheet, the image forming position being a position at which the image forming portion forms an image on a sheet, and
wherein the control portion executes the first recovery operation in a case where size disagreement is detected as the first error, the size disagreement being an error in which a size of an image formed by the image forming portion and a sheet size detected by the size detection portion do not match each other.

6. The image forming apparatus according to claim 1, wherein in a case where the first error is detected by the error detection portion, the control portion continues the image forming operation performed by the image forming portion, while executing the first recovery operation.

7. The image forming apparatus according to claim 1, wherein in a case where the second error is detected by the error detection portion, the control portion stops the image forming operation performed by the image forming portion, until the second error is cleared.

8. The image forming apparatus according to claim 1, wherein the error detection portion includes a sheet sensor configured to detect a sheet in a conveyance path disposed in the casing, and
wherein the control portion is configured to execute the second recovery operation in a case where a sheet jam is detected as the second error by the sheet sensor.

9. The image forming apparatus according to claim 8, wherein in a case where the second error is detected on a first sheet by the error detection portion, the control portion determines, in the second recovery operation, which of the first stacking portion and the second stacking portion a second sheet left in the conveyance path is to be discharged based on a position of the second sheet.

10. The image forming apparatus according to claim 1, further comprising a lock mechanism configured to lock the door portion on the casing in a state where the door portion is closed with respect to the casing while the image forming operation is being executed.

11. The image forming apparatus according to claim 1, wherein the number of sheets that are capable of being stacked on the first stacking portion is larger than the number of sheets that are capable of being stacked on the second stacking portion.

12. The image forming apparatus according to claim 1, further comprising a duplex conveyance path configured to convey a sheet on which an image has been formed on a first side in the image forming portion to the image forming portion again,
wherein the second stacking portion is disposed so as to branch from the duplex conveyance path.

13. The image forming apparatus according to claim 1, wherein the door portion is arranged such that the sheet on the second stacking portion is able to be accessed in a case where the door portion is opened.

14. The image forming apparatus according to claim 1, wherein in a case where the second error is detected by the error detection portion, the control portion controls, in the second recovery operation, the conveyance portion to discharge a sheet left in a conveyance path in the casing to the second stacking portion.
